(19) United States
(12) Patent Application Publication
(10) Pub. No.: US 2006/0206896 A1
(43) Pub. Date: Sep. 14, 2006

(54) Allocation class selection for file storage

(76) Inventor: Wilhelmus Franciscus Johannes Fontijn, Eindhoven (NL)

Correspondence Address: PHILIPS INTELLECTUAL PROPERTY & STANDARDS, P.O. BOX 3001, BRIARCLIFF MANOR, NY, 10510, US

(21) Appl. No.: 10/552,761

(22) PCT Filed: Apr. 5, 2004
(86) PCT No.: PCT/IB04/50392

§ 371 Date: Oct. 12, 2005

(30) Foreign Application Priority Data
Apr. 14, 2003 (EP) 03101007.7

(51) Int. Cl. G06F 9/46

(52) U.S. Cl. 718/104

(57) ABSTRACT

The present invention relates to a method and storage device for storing data on a recording medium (40) by using allocation classes to optimize storage and retrieval of the data based on properties of their content. A type of data is discriminated based on a predetermined property of the data, and a usage pattern is tracked for discriminated types of the input data, so as to select the allocation class based on the usage pattern. Thereby, without the content source knowing or telling the type of content it produces, the storage of the same will be, at least after a while, optimal for the properties of the combination of content and storage device.

The present invention relates to a method and storage device for storing data on a recording medium, such as an optical disc, by using allocation classes to optimize storage and retrieval of the data based on properties of their content.

The applicant is developing a miniature optical disc that records, plays back and erases data using the same precision blue lasers that are being developed for the next generation of optical disc based high-definition video recorders. The system of the miniature optical disc is known as SFFO (Small Form Factor Optical) or PB (Portable Blue) and shows that it is possible to store 4 Gigabytes on a 3-cm-disc, and to make a drive as small as a memory card that can read it reliably. The SFFO disc will have a well-defined logical format according to a standard file system, such as UDF (Universal Disk Format).

However, a host device or data source connected to such an advanced optical disc drive via a legacy interface may not be aware that it is dealing with an optical disc. Moreover, host devices or data sources may not understand this format and so they may write data in a way that is not compliant to the SFFO disc format.

Furthermore, optical media have a limited number of rewrites available, e.g. 1000. A host device that does not take into account (because it is not aware of the fact) that it is writing to an optical disc may constantly write to the same location, e.g. with the file system data, resulting in a failure of that part of the disc. This may result in the complete disc being unusable if the location of the failure includes critical data such as the file system. Some advanced features of file system implementations rely on accurate information about the files that are stored, to combat this problem. For instance, the SFFO logical format uses concepts like the volatile file location class for files that are written often. In general, storage devices, such as SFFO disc drives, can use allocation classes to optimize storage and retrieval of data based on the properties of the content stored. This is especially useful when resources are scarce, such as typically with portable devices. Many sources of content will not know to which allocation class the content they want to store belongs. Nor will the source tell that storage device which type of content it produces or what kind of device it is. Storing this content without further measures will lead to a sub-optimal allocation of the content stored.

Low power portable storage devices, such as SFFO drives, can use allocation classes to optimize storage and retrieval of data based on the properties of the content stored. A storage device typically stores all data the same way irrespective of the extension, source, or type of content.

The present invention provides a method and storage device using allocation classes, by means of which the selection of allocation classes can be optimized even if the source devices do not communicate their type and are not aware of allocation classes used.

A storage device according to the invention is claimed in claim 1 and a method according to the invention is claimed in claim 10.

Accordingly, the type of input data or content is discriminated and the usage pattern is tracked for discriminated types of input data to thereby estimate the properties of the input data to be stored. This provides the advantage that without the content source knowing or telling the type of content it produces, the storage of the same will be, at least after a while, optimized for the properties of the combination of content and storage device. The discriminating means may be arranged to discriminate the type of the input data based on at least one of a file extension, a kind of data source, and a file size of the input data. The extension of a file provides a good indication of the type of content it contains, such that a good criteria for discrimination and allocation class selection is given. Furthermore, source devices which do not communicate their type and are unaware of allocation classes typically produce one type of content. Hence, the kind or type of data source provides another good indicator for discrimination and allocation class selection. Although the file size provides a less robust way of selecting allocation classes, it may be used at least as a backup.

The class selection means may be arranged to predict the usage pattern for a predetermined file extension. This provides the advantage that for certain extensions, the usage pattern required for allocation class selection can be predicted in advance such that an adequate allocation class assignment can be assured right from the beginning of the receipt of respective data.

Furthermore, the class selection means may be arranged to select a best effort allocation class for files with a first file extension indicating a still picture, a low rate stream allocation class for files with a second file extension indicating an audio file, and a high rate stream allocation class for a third file extension indicating a video file. In particular, the first file extension may be a JPG extension, the second file extension may be an MP3 or AAC extension, and the third file extension may be an MPG extension.

Input buffer means may be provided for caching the input data. Then, the class selection means may be arranged to assume a video file if the input buffer means indicates an overflow before the end of file has been stored. Thereby, an appropriate allocation class can be selected even if the device was not able to ascertain the extension of the file or the kind of source device.

In addition, the class selection means may be arranged to select a volatile file allocation class if the usage pattern indicates a writing frequency greater or equal to a predetermined threshold. Thereby, deterioration of an optical disc due to excess writing procedures on a particular area of the disc can be prevented by shifting the location of the written files.

The usage pattern may comprise a storage pattern and a retrieval pattern.

Further advantageous modifications are defined in the dependent claims.

The present invention will now be described on the basis of a preferred embodiment with reference to the accompanying drawings, in which:

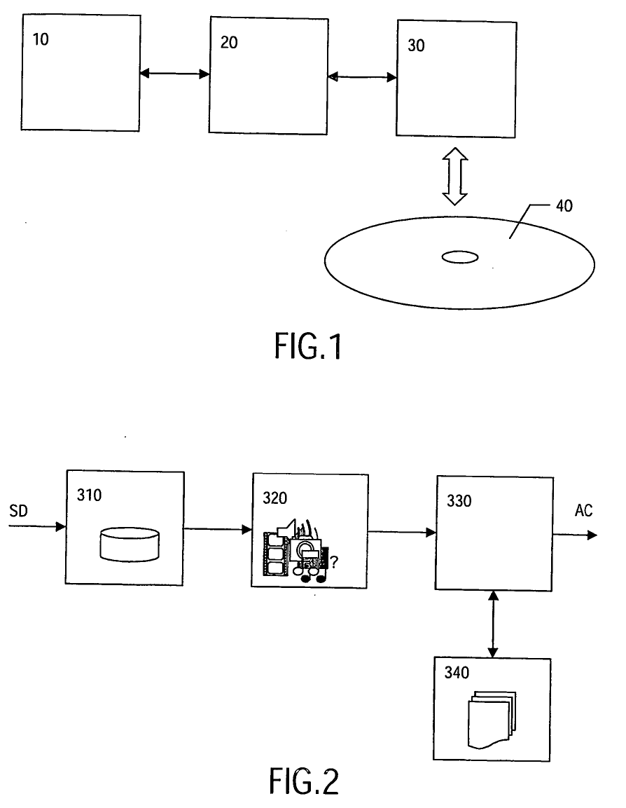

FIG. 1 shows a schematic block diagram of a video camera using an optical drive as a storage device; and

FIG. 2 shows a schematic block diagram of an allocation class assignment portion of the storage device according to the preferred embodiment.

The preferred embodiment will now be described on the basis of a video camera 10 which uses an optical drive 30, such as an SFFO drive, as a storage device connected to an interface unit 20, e.g. a CF II (Compact Flash II) interface, as indicated in FIG. 1.

According to FIG. 1, the video camera 10 is connected via the interface unit 20 to the optical drive 30 which is adapted to write input data to an optical disc 40, which may be a phase change or a magneto-optical disc. The file system used in the optical drive 30 may be arranged to assign allocation classes as a way of storing specific type of files in a specific way and/or on a specific location. The use of allocation classes is useful especially if the storage medium or device has certain properties that limit the performance on a certain aspect. Examples of such a device include SFFO, in particular.

Until recently, optical discs have not been used intensively as true random access devices. With the introduction of transparent defect management and speed-up of read and write cycles for optical discs, this type of use is expected to be intensified. Multiple portable device types, e.g. video cameras or mobile phones, are expected to have SFFO as primary storage. However, repeated writing of the same file on the same location will cause problems due to the limited recyclability of optical discs. The information area provided on the optical disc 40 consists of lead-in, program area, lead-out. The lead-in includes the disc navigation area and the digital rights management area, the program area includes areas for the location of volatile files, start-up files and file system meta data The disc navigation area is a space reserved for pointers and application specific data Additionally, the disc navigation area can be used for reserving space in the program area for specific file systems, allocation classes or applications, for assigning properties or attributes to the reserved space, and/or for providing pointers in the reserved space and room for application specific data. For certified allocation classes, specific areas can be reserved in the program area. These classes may comprise volatile files which are files of a certain size that are written often.

The volatile file area is located towards the outside of the disc 40 to achieve a high writing speed. Volatile files may be relocated, e.g., each time they are written. The space reserved for the volatile files should in that case be at least double of the expected combined size of the volatile files.

Additionally, other allocation classes may be defined, such as a low rate stream allocation class e.g. for audio files, a best effort allocation class e.g. for audio or still picture files, and a high rate stream allocation class for video files.

In general, the storage device uses allocation classes to optimize storage and retrieval of data based on the properties of the content stored. This is especially useful when resources are scares, such as typically with portable devices. However, many sources of content will not know to which allocation class the content it wants to store belongs. Nor will the source tell the storage device which type of content it produces or what kind of device it is. Storing this content without further measures will lead to a sub-optimal selection or assignment of allocation classes.

According to the preferred embodiment, the input data received by the optical drive 30 from the video camera 10 via the interface unit 20 is discriminated as to the type of content or type of source or file length to gain information used for selecting a proper allocation class. This provides the advantage that without the source knowing or telling the type of content it produces, the storage of the same will be at least after a while optimal for the properties of the combination of content and storage device. The discrimination may be based on determination of the extensions of the files that contain the content or the source of the content or the file size. The discriminated input data is then individually tracked with regard to their usage pattern, e.g. storage and retrieval patterns indicating number or frequency storage and retrieval actions, to obtain information on the kind of content.

The interface 20 may be a standard interface for connecting storage devices to hosts such as personal computers or digital cameras or the like. Thereby, it is possible to use different storage technologies in conjunction with the same interface. Therefore, although the video camera 10 may be able to interface with the optical drive 30, there is no guarantee that it can understand the way data is stored on the optical disc 40. The optical drive 30 presents. itself to the video camera 10 as a logical address space. As already mentioned above, the interface unit 20 may be a Compact Flash (CF) interface to a video camera 10. The video camera 10 will store pictures using the FAT file system through the CF interface unit 20.

The optical drive 30 retrieves the extensions of the files that contain the content and subsequently tracks the storage and retrieval patterns for data stored in files with that extension. Additionally or alternatively, the storage and retrieval patterns for data stored by a certain source of the content may be tracked. As another less robust way of assigning the allocation class, the file size could be used. This additional discrimination criteria could be used in isolation for rough discrimination or as a backup discrimination which is less accurate.

The extension of a file can be regarded as a good indication of the type of content it contains, e.g. a JPG extension points to a still picture, a MPG extension to a movie, and a MP3 or AAC extension to a music file. Furthermore, source devices that do not communicate their type and are unaware of allocation classes typically produce one type of content, such that the kind of source device can also be regarded as a fair indicator for the type of content.

For certain extensions, the usage pattern can be predicted upfront, e.g. a JPG file is always a picture. Furthermore, it is noted that it may happen that some data, e.g. the first part of a file, needs to be stored before the optical drive 30 is able to a ascertain the extension of the file or the nature of the source device. This typically happens for large files, i.e. larger than the fragment size, which are typically big data files or movies. For the next file received from the same device, an appropriate allocation class can be selected based on the first file.

The video camera 10 does not know the difference between flash cards and optical drives such as SFFO drives. Hence, it does not know the allocation class for storing its video data on the optical disc 40, nor will it communicate the fact that it produces a video file. In fact, it can also produce still pictures and separate compressed audio files. The video camera 10 just sends its data across the interface unit 20.

The optical drive 30 may associate the best effort allocation class to files with the JPG extension and high rate stream allocation class to files with the MPG extension. Furthermore, the low rate stream allocation class or the best effort allocation class can be assigned to files with the MP3 or AAC extension.

FIG. 2 shows a schematic block diagram of an allocation class determination portion of the optical drive 30. Source data SD received from the interface unit 20 is supplied to a write buffer 310 so as to cache the source data SD. Then, the cached data is supplied to a discrimination unit 320 for discriminating the content of the data based on the file extension, kind of source or file length. Of course, other suitable properties of the source data SD could be used to discriminate the content for assignment of allocation classes.

Based on the discrimination in the discrimination unit 320, an allocation class selection unit 330 generates and stores usage patterns for usage pattern tracking in a tracking unit 340. In particular, storage patterns and retrieval patterns of the source data SD are tracked for each type of content as discriminated in the discrimination unit 320. Using the registered or accumulated usage patterns, the allocation class selection unit 330 selects or assigns an allocation class to the discriminated types of content.

For example, as the video camera stores a still image on the optical disc 40, the JPG file is first cached in the write buffer 310, which may be an MRAM (Magneto-resistive Random Access Memory), as all data is, until the write buffer 310 is full. This requires several pictures. Hence, before the first picture is written to the optical disc 40, a file extension is clear. The current content is then assigned the best effort allocation class by the allocation class selection unit 330 and the content is correspondingly stored using the selected allocation class AC.

On the other hand, as the video camera 10 stores a movie on the optical disc 40, it is first cached in the write buffer 310. However, this will overflow before the end of the file when the video camera 10 typically sends the file name and the extension. Then, the allocation class selection unit 330 could decide to assign the best effort allocation class, as it may gather from the usage pattern of the tracking unit 340 that the previous material received from the same source were still pictures. However, the allocation class selection unit 330 decides that the size warrants the assumption that it is a video file which is being stored and assigns the high rate stream allocation class.

As the video camera 10 starts to store its proprietary audio file format using the MP3 or AAC extension, the allocation class selection unit 330 uses the best effort allocation class due to the earlier still pictures received from the same source. Then it records the MP3 or AAC extension in the tracking unit 340 and tracks the usage of the file. It is noted that the data blocks of this type of file typically requested at a certain rate, as it is streamed for replay. Based on the usage pattern, the allocation class selection unit 330 selects the low rate stream allocation class to the MP3 or AAC extension after a while. For any next MP3 or AAC file, the low rate stream allocation class will then be selected or assigned.

Furthermore, an allocation classes for volatile files and non-volatile or robust files may be selected based an access or writing frequency derived from the usage pattern. E.g., when the writing frequency is greater or equal to a predetermined threshold indicating a volatile file, the volatile file allocation class is selected by the allocation class selection unit 330. Otherwise, the non-volatile or robust file allocation is selected.

It is noted that blocks 320 to 340 may be implemented as separate hardware blocks or may be implemented as software routines controlling a processing unit.

Moreover, the discrimination criteria file extension, file source or file size may be used separately or in combination to optimize the allocation class selection.

Thus, the present invention is not restricted to the above preferred embodiment but can be used in any storage device using allocation classes to optimize storage tailored to the properties of the content stored and legacy sources or sources unaware of the properties of the content generated by these sources. The preferred embodiment may thus vary within the scope of the attached claims.

1. A storage device for storing data on a recording medium (40) by using allocation classes for optimizing storage and retrieval of said data based on properties of their content, said device comprising:
a) discriminating means (320) for discriminating a type of said data based on a predetermined property of said data;
b) tracking means (340) for tracking a usage pattern for a discriminated type of said data; and
c) class selection means (330) for selecting an allocation class used for storing said discriminated type of data, based on said usage pattern.

2. A device according to claim 1, wherein said discriminating means (320) is arranged to discriminate said type of said data based on at least one of a file extension, a kind of data source, and a file size of said data.

3. A device according to claim 1 wherein said recording medium is an optical disc (40).

4. A device according to claim 1, wherein said class selection means (330) is arranged to predict said usage pattern for a predetermined file extension.

5. A device according to claim 1, wherein said storage device comprises an optical disc recording device (30).

6. A device according to claim 1, wherein said class selection means (330) is arranged to select a best effort allocation class for files with a first file extension indicating a still picture, a low rate stream allocation class for files with a second file extension indicating an audio file, and a high rate stream allocation class for a third file extension indicating a video file.

7. A device according to claim 1, further comprising buffer means (310) for caching said data.

8. A device according to claim 7, wherein said class selection means (330) is arranged to assume a video file if said buffer means (310) indicates an overflow before the end of file has been stored.

9. A device according to claim 1, wherein said class selection means (330) is arranged to select a volatile file allocation class if said usage pattern indicates a writing frequency greater or equal to a predetermined threshold.

10. A method of selecting an allocation class used for storing data on a recording medium (40), said method comprising the steps of:
a) discriminating a type of data based on a predetermined property of said data;
b) tracking a usage pattern for a discriminated type of said data; and
c) selecting said allocation class based on said usage pattern.

11. A method according to claim 10, wherein said predetermined property comprises at least one of a file extension, a kind of data source, and a file size.

12. A method according to claim 10, further comprising the steps of predicting said usage pattern for a predetermined file extension.

13. A method according to claim 10, wherein said allocation class is selected from a set of allocation classes comprising a best effort allocation class, a high rate stream allocation class, a low rate stream allocation class, a volatile file allocation class, and a non-volatile file allocation class.
